(19) United States
(12) Patent Application Publication
(10) Pub. No.: US 2015/0365638 A1
(43) Pub. Date: Dec. 17, 2015

(54) SOLID-STATE IMAGING DEVICE AND SIGNAL PROCESSING METHOD

(71) Applicant: Kabushiki Kaisha Toshiba, Minato-ku (JP)

(72) Inventors: Yukiyasu TATSUZAWA, Yokohama (JP); Tatsuji Ashitani, Yokohama (JP); Kazuhiro Hiwada, Yokohama (JP); Shinichi Asanuma, Kawasaki (JP)

(73) Assignee: Kabushiki Kaisha Toshiba, Minato-ku (JP)

(21) Appl. No.: 14/635,354

(22) Filed: Mar. 2, 2015

(30) Foreign Application Priority Data
Jun. 16, 2014 (JP) 2014-123750

(51) Int. Cl. H04N 9/04; H04N 5/374; H04N 5/376; G06T 3/40

(52) U.S. Cl. CPC H04N 9/045; G06T 3/4015; H04N 5/374; H04N 5/3742; H04N 5/3765; H04N 2209/041

(57) ABSTRACT

According to one embodiment, a signal processing circuit includes a defect correction circuit. The defect correction circuit includes a color difference calculation part, a color difference sorting part, and a correction amount calculation part. The color difference calculation part is configured to calculate a difference between a signal level of a first pixel and a signal level of a second pixel in a pixel group. The pixel group includes pixels juxtaposed in a horizontal direction with a target pixel at a center. The correction amount calculation part is configured to calculate a correction amount for the target pixel, based on a difference chosen by the color difference sorting part and a signal level of a second pixel adjacent to the target pixel.

### CROSS-REFERENCE TO RELATED APPLICATIONS

This application is based upon and claims the benefit of priority from Japanese Patent Application No. 2014-123750, filed on Jun. 16, 2014; the entire contents of which are incorporated herein by reference.

### FIELD

An embodiment described herein relates generally to a solid-state imaging device and signal processing method.

### BACKGROUND

As a solid-state imaging device, there is a type equipped with a defect correction circuit. The defect correction circuit detects a relative abnormality of signals from pixels, and repairs the abnormality by use of a signal process. If the defect correction circuit includes line memories, it can perform defect correction by utilizing information about pixels in two-dimensional directions, but it increases the circuit scale. Further, the defect correction circuit is desired to reduce error correction.

### BRIEF DESCRIPTION OF THE DRAWINGS

FIG. 1 is a block diagram showing a schematic configuration of a solid-state imaging device according to an embodiment;

FIG. 2 is a block diagram showing a schematic configuration of a camera system equipped with the solid-state imaging device shown in FIG. 1;

FIG. 3 is a block diagram showing a configuration of a defect correction circuit shown in FIG. 1;

FIG. 4 is a view showing a configuration example of a color difference judgment circuit shown in FIG. 3;

FIG. 5 is a view showing an example of a pixel group included in a pixel array shown in FIG. 1;

FIG. 6 is a flow chart showing a sequence of calculating a correction amount for white defect correction in the color difference judgment circuit shown in FIG. 3;

FIG. 7 is a view showing a configuration example of a flatness judgment circuit shown in FIG. 3;

FIG. 8 is a flow chart showing a sequence of calculating a correction amount for white defect correction in the flatness judgment circuit shown in FIG. 3;

FIG. 9 is a view showing a configuration example of a brightness judgment circuit shown in FIG. 3; and

FIG. 10 is a flow chart showing a sequence of calculating a correction amount for white defect correction in the brightness judgment circuit shown in FIG. 3.

### DETAILED DESCRIPTION

In general, according to one embodiment, a solid-state imaging device includes an image sensor and a signal processing circuit. The image sensor includes a pixel array. The pixel array is composed of pixels arrayed in horizontal directions and vertical directions. The signal processing circuit is configured to process image signals from the image sensor. The signal processing circuit includes a defect correction circuit. The defect correction circuit is configured to correct a signal level of a target pixel judged as a defect by comparing signals of a pixel group. The pixel group includes the target pixel. The pixel group includes pixels juxtaposed in a horizontal direction with the target pixel at a center. The defect correction circuit includes a color difference calculation part, a color difference sorting part, and a correction amount calculation part. The color difference calculation part is configured to calculate a difference between a signal level of a first pixel and a signal level of a second pixel in the pixel group. The first pixel is for detecting first color light. The second pixel is adjacent to the first pixel. The second pixel is for detecting second color light. The color difference sorting part is configured to choose one of differences calculated in association with first pixels and second pixels included in the pixel group. The correction amount calculation part is configured to calculate a correction amount for defect correction on the target pixel, based on a difference chosen by the color difference sorting part and a signal level of a second pixel adjacent to the target pixel in the pixel group.

An exemplary embodiment of a solid-state imaging device and signal processing method will be explained below in detail with reference to the accompanying drawings. The present invention is not limited to the following embodiment.

### Embodiment

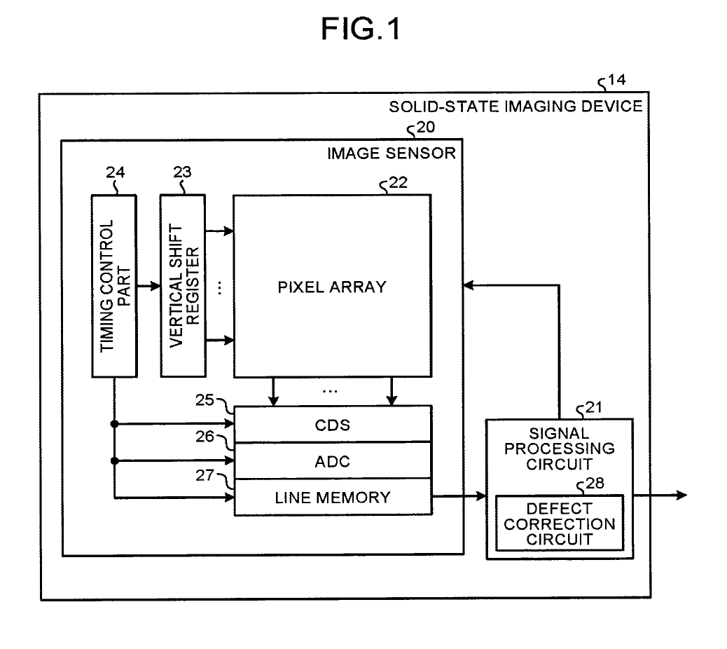

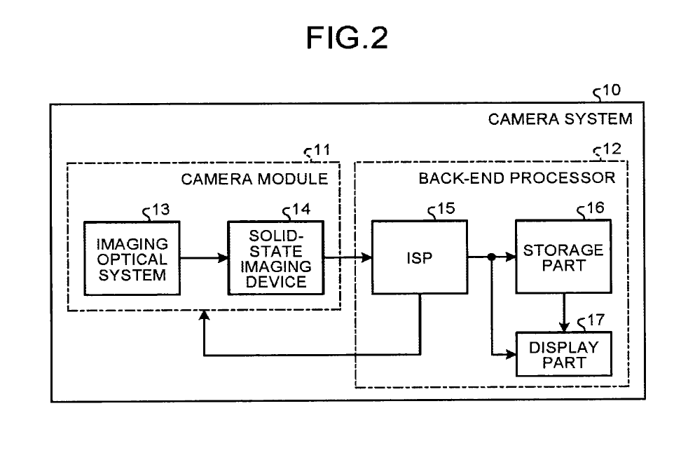

FIG. 1 is a block diagram showing a schematic configuration of a solid-state imaging device according to an embodiment. FIG. 2 is a block diagram showing a schematic configuration of a camera system equipped with the solid-state imaging device shown in FIG. 1.

The camera system 10 is an electronic apparatus including a camera module 11, such as a mobile terminal apparatus with a camera. The camera system 10 may be an electronic apparatus other than a mobile terminal apparatus with a camera, such as a digital still camera or digital video camera.

The camera system 10 includes the camera module 11 and a back-end processor 12. The camera module 11 includes an imaging optical system 13 and a solid-state imaging device 14. The back-end processor 12 includes an image signal processor (ISP) 15, a storage part 16, and a display part 17.

The imaging optical system 13 takes in light from an object and forms an object image. The solid-state imaging device 14 images the object image. The ISP 15 performs a signal process to the image signal obtained by the imaging in the solid-state imaging device 14. The storage part 16 stores the image subjected to the signal process by the ISP 15. The storage part 16 outputs an image signal to the display part 17, in response to user operations or the like.

The solid-state imaging device 14 includes an image sensor 20 and a signal processing circuit 21. The image sensor 20 images an object image. The image sensor 20 is a CMOS image sensor, for example. The image sensor 20 includes a pixel array 22, a vertical shift register 23, a timing control part 24, a correlative double sampling part (CDS) 25, an analog/digital conversion parts (ADC) 26, and a line memory 27.

The pixel array 22 is arranged within an imaging area of the image sensor 20. The pixel array 22 is composed of pixels arranged in an array format in horizontal directions (row directions) and vertical directions (column directions). Each of the pixels includes a photo diode serving as a photoelectric conversion element. The photoelectric conversion element generates a signal charge corresponding to incident light quantity. Each of the pixels accumulates the signal charge corresponding to incident light quantity.

Each of the pixels is provided with a color filter (not shown) on the incident side, in accordance with the color array. Each of the pixels detects color light transmitted through the color filter. The pixels of different colors, which are assigned to detect respective color components of light, are arranged to form a Bayer array.

The timing control part 24 generates clocks for controlling various kinds of timing. The timing control part 24 outputs a vertical scan clock corresponding to a vertical synchronous signal to the vertical shift register 23. The timing control part 24 outputs a horizontal scan clock corresponding to a horizontal synchronous signal to the line memory 27. The timing control part 24 outputs a timing signal for instructing drive timing to each of the CDS 25 and the ADC 26.

The vertical shift register 23 selects a row of pixels to read signals therefrom, in response to the vertical scan clock from the timing control part 24. The vertical shift register 23 outputs a read signal to each of the pixels on the selected row. Upon reception of an input of the read signal from the vertical shift register 23, each of the pixels outputs a signal charge accumulated therein to the corresponding one of vertical signal lines (not shown). The pixel array 22 outputs signals from the pixels through the vertical signal lines to the CDS 25.

The CDS 25 performs a correlative double sampling process for reducing fixed pattern noises, to signals from the pixel array 22. The ADC 26 converts analog type signals to digital type signals. The line memory 27 accumulates signals from the ADC 26. The image sensor 20 outputs signals accumulated in the line memory 27.

The signal processing circuit 21 can perform various kinds of signal processes to an image signal from the image sensor 20. The signal processing circuit 21 includes a defect correction circuit 28. The defect correction circuit 28 performs defect correction to an image signal from the image sensor 20. The defect is a relative abnormality of signals from the pixels. The defect correction circuit 28 performs defect judgment for detecting an abnormality to each of the pixels of the pixel array 22, and then performs a signal process to repair the signal including the abnormality thereby detected. As a defect of this kind, there is a white defect and a black defect. The white defect is a defect showing a signal level higher than the signal level corresponding to light quantity detected at the pixel. The black defect is a defect showing a signal level lower than the signal level corresponding to light quantity detected at the pixel.

The signal processing circuit 21 can perform various kinds of signal processes other than defect correction, such as gamma correction, noise reduction process, lens shading correction, white balance adjustment, distortion correction, and resolution restoration. FIG. 1 does not show the configurations other than the defect correction circuit 28, included in the signal processing circuit 21.

The solid-state imaging device 14 outputs an image signal subjected to a signal process by the signal processing circuit 21 to the outside of the chip. The solid-state imaging device 14 performs feedback control to the image sensor 20, based on data derived from a signal process by the signal processing circuit 21.

In this embodiment, the camera system 10 may be designed such that the ISP 15 of the back-end processor 12 can perform at least any one of the various kinds of signal processes that have been mentioned above as being performed by the signal processing circuit 21. Alternatively, the camera system 10 may be designed such that both of the signal processing circuit 21 and the ISP 15 can perform at least any one of the various kinds of signal processes. The signal processing circuit 21 and the ISP 15 may be designed to perform a signal process other than the signal processes described in this embodiment.

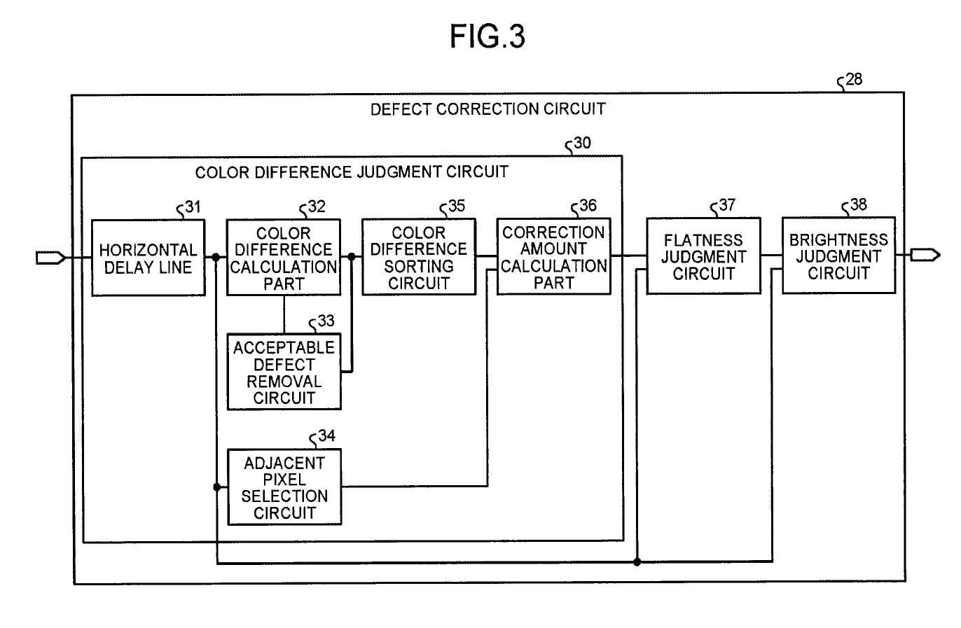

FIG. 3 is a block diagram showing a configuration of the defect correction circuit shown in FIG. 1. The defect correction circuit 28 performs dynamic defect correction that detects a defect from an image signal during an operation of the camera module 11. The defect correction circuit 28 is configured to mainly correct defects that are randomly generated depending on the temperature characteristic and/or light exposure time of the photo diodes.

The solid-state imaging device 14 may include a configuration for performing map defect correction, other than the defect correction circuit 28. The map defect correction is to mainly correct defects that are constantly generated due to structural matters of the photo diodes, such as an imperfection of the multilayer structure or a leakage current at the floating junction.

The defect correction circuit 28 performs defect correction by utilizing information about pixels present in a juxtaposed state in the horizontal direction. The defect correction circuit 28 refers to the signal levels of a target pixel and its neighboring pixels included in a pixel group composed of pixels juxtaposed in the horizontal direction. The target pixel is positioned at the center of the pixel group. The target pixel is defined by a pixel taken as a target of defect judgment at certain timing. The defect correction circuit 28 performs defect correction to the target pixel judged as a defect, by replacing the signal.

The neighboring pixels are pixels other than the target pixel and included in the pixel group. In this embodiment, an identical color pixel described later is a pixel for detecting color light the same as that of the target pixel, among the neighboring pixels. The identical color pixel is a first pixel for detecting first color light. Further, a different color pixel is a pixel for detecting color light different from that of the target pixel, among the neighboring pixels. The different color pixel is a second pixel for detecting second color light.

The defect correction circuit 28 includes a color difference judgment circuit 30, a flatness judgment circuit 37, and a brightness judgment circuit 38. The color difference judgment circuit 30 performs an arithmetical operation for color difference judgment, which compares the color difference between the target pixel and a different color pixel adjacent thereto with the color difference between an identical color pixel and a different color pixel adjacent thereto. The color difference judgment circuit 30 calculates a correction amount for defect correction, in accordance with the color difference judgment.

The flatness judgment circuit 37 performs flatness judgment by calculating the dispersion of the signal levels of identical color pixels. The flatness judgment circuit 37 calculates a correction amount for defect correction, in accordance with the flatness judgment. The brightness judgment circuit 38 performs brightness judgment by comparing the signal level of a different color pixel adjacent to the target pixel with the signal level of a different color pixel other than that mentioned above. The brightness judgment circuit 38 calculates a correction amount for defect correction, in accordance with the brightness judgment.

The color difference judgment circuit 30 includes a horizontal delay line 31, a color difference calculation part 32, an acceptable defect removal circuit (acceptable defect removal part) 33, an adjacent pixel selection circuit (adjacent pixel selection part) 34, a color difference sorting circuit (color difference sorting part) 35, and a correction amount calculation part 36. The horizontal delay line 31 holds signals from the respective pixels in the pixel group, and thereby synchronizes the signals from the respective pixels. The color difference calculation part 32 calculates the difference between the signal level of an identical color pixel and the signal level of a different color pixel adjacent to this identical color pixel.

The acceptable defect removal circuit 33 removes, from an arithmetical operation, one of the identical color pixels positioned at the ends of the pixel group as a defect to be accepted in the pixel group. The adjacent pixel selection circuit 34 serving as a selection circuit selects one of the two different color pixels adjacent to the target pixel in the pixel group. The color difference sorting circuit 35 chooses the maximum value and the minimum value from respective differences calculated in association with identical color pixels and different color pixels included in the pixel group. The correction amount calculation part 36 calculates a correction amount for the target pixel, based on a difference chosen by the color difference sorting circuit 35 and the signal level of a different color pixel selected by the adjacent pixel selection circuit 34.

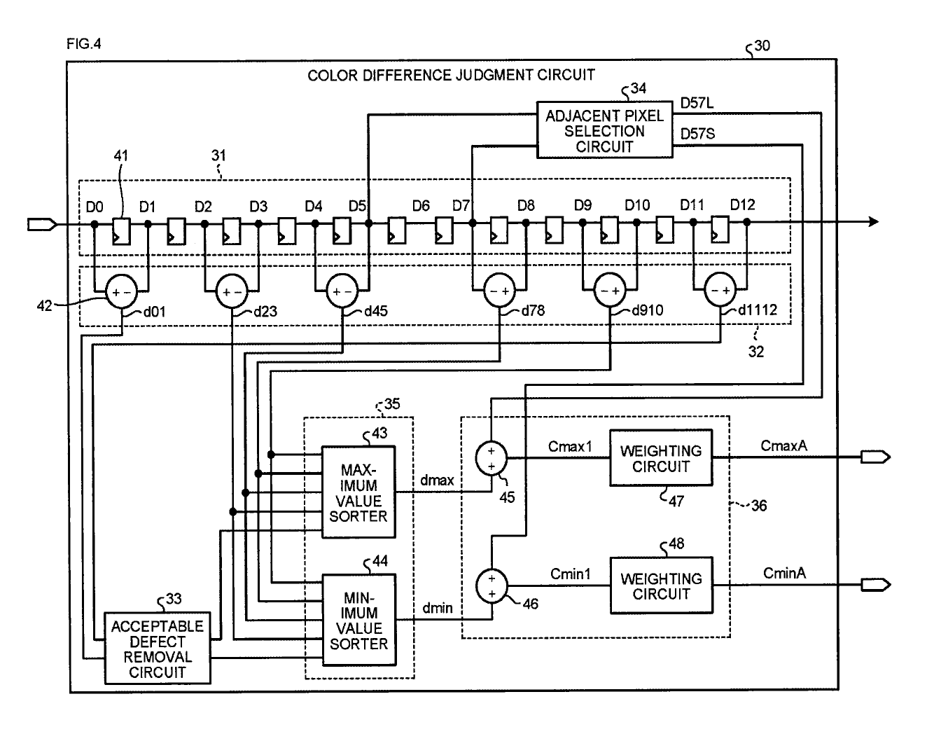

FIG. 4 is a view showing a configuration example of the color difference judgment circuit shown in FIG. 3. The horizontal delay line 31 includes twelve flip-flops 41 connected in series. When signals are sequentially input from the respective pixels juxtaposed in the horizontal direction into the color difference judgment circuit 30, the horizontal delay line 31 holds signals from twelve pixels. The horizontal delay line 31 applies a delay in the horizontal direction to each of these twelve pixel signals. The horizontal delay line 31 synchronizes each of the twelve pixel signals (D1 to D12) held therein with an input signal (D0) from one pixel.

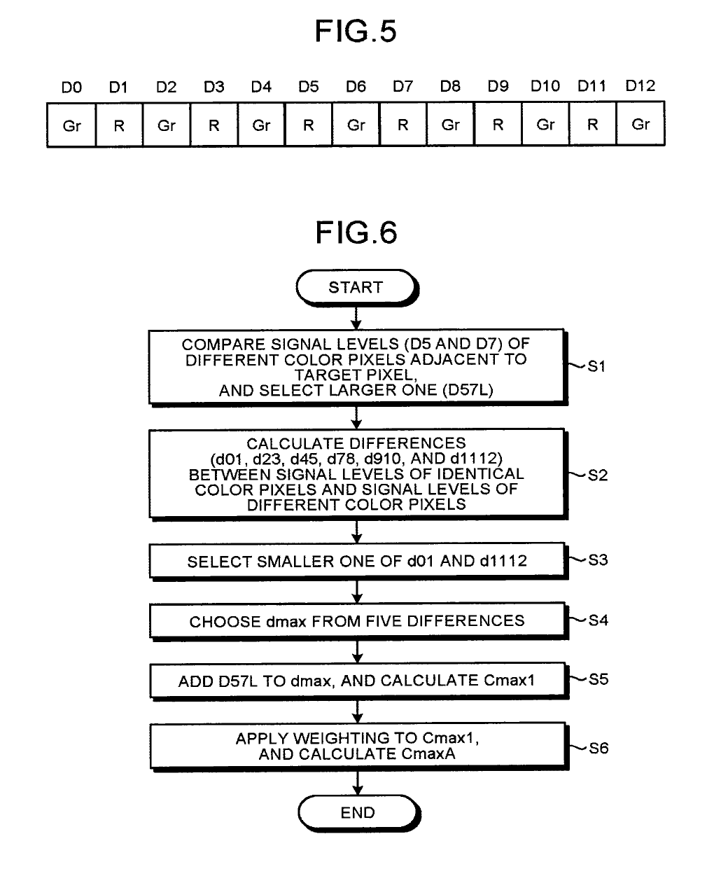

FIG. 5 is a view showing an example of the pixel group included in the pixel array shown in FIG. 1. The Bayer array of the pixel array 22 is configured by use of a set of four pixels as a unit, which is composed of Gr, R, Gb, and B pixels. The R pixel detects red color light. The B pixel detects blue color light. The Gr pixel and Gb pixel detect green color light. The Gr pixel is adjacent to the R pixel in the horizontal direction. The Gb pixel is adjacent to the B pixel in the horizontal direction. The pixel group is composed of pixels present in a juxtaposed state in the horizontal direction.

In the example shown in FIG. 6, the pixel group is composed of seven Gr pixels and six R pixels. The Gr pixel positioned at the center of the pixel group is the target pixel. D6 denotes the signal of the target pixel. The twelve pixels other than the target pixel are neighboring pixels. Of them, the six Gr pixels are identical color pixels, and the six R pixels are different color pixels. D0, D2, D4, D8, D10, and D12 respectively denote the signals of the identical color pixels. D1, D3, D5, D7, D9, and D11 respectively denote the signals of the different color pixels. The identical color pixels detect green color light, which is first color light. The different color pixels detect red color light, which is second color light.

In a case where the target pixel is an R pixel, the six R pixels included in the pixel group are identical color pixels, and the six Gr pixels are different color pixels. The first color light is red color light. The second color light is green color light. In a case where the target pixel is a B pixel, the six B pixels included in the pixel group are identical color pixels, and the six Gb pixels are different color pixels. The first color light is blue color light. The second color light is green color light. In a case where the target pixel is a Gb pixel, the six Gb pixels included in the pixel group are identical color pixels, and the six B pixels are different color pixels. The first color light is green color light. The second color light is blue color light.

The signals D5 and D7 of the two different color pixels adjacent to the target pixel are input into the adjacent pixel selection circuit 34. The adjacent pixel selection circuit 34 compares the D5 and D7 with each other. The adjacent pixel selection circuit 34 selects one of the D5 and D7, which has a higher signal level, to use it for white defect correction. The adjacent pixel selection circuit 34 outputs the selected signal (D57L). Further, the adjacent pixel selection circuit 34 selects one of the D5 and D7, which has a lower signal level, to use it for black defect correction. The adjacent pixel selection circuit 34 outputs the selected signal (D57S). The adjacent pixel selection circuit 34 compares with each other the signal levels of the two pixels adjacent to the target pixel in the horizontal direction. The adjacent pixel selection circuit 34 selects one of the signals of the two pixels, based on the comparison result.

The color difference calculation part 32 includes six difference calculators 42. Each of the difference calculators 42 obtains the difference between signal levels in a set of an identical color pixel and a different color pixel adjacent to each other. The color difference calculation part 32 outputs the difference d01 between the D0 and D1, the difference d23 between the D2 and D3, the difference d45 between the D4 and D5, the difference d78 between the D7 and D8, the difference d910 between the D9 and D10, and the difference d1112 between the D11 and D12.

The two differences d01 and d1112 are input into the acceptable defect removal circuit 33. The identical color pixel corresponding to the D0 is positioned at a first end of the pixel group in the horizontal direction. The identical color pixel corresponding to the D12 is positioned at a second end of the pixel group opposite to the first end. The acceptable defect removal circuit 33 removes larger one of the two differences d01 and d1112 from an arithmetical operation for white defect correction. Further, the acceptable defect removal circuit 33 removes smaller one of the two differences d01 and d1112 from an arithmetical operation for black defect correction.

The color difference sorting circuit 35 includes a maximum value sorter 43 and a minimum value sorter 44. The maximum value sorter 43 chooses the maximum value from the respective differences. The minimum value sorter 44 chooses the minimum value from the respective differences. The d23, d45, d78, and d910 are input into each of the maximum value sorter 43 and the minimum value sorter 44 from the color difference calculation part 32. The color difference sorting circuit 35 is a sorting circuit configured to choose one of the differences obtained by the difference calculator 42, based on the order of levels of the differences.

The acceptable defect removal circuit 33 selects one of the two differences d01 and d1112 to be left for an arithmetical operation for white defect correction, i.e., the smaller one of them, and outputs it to the maximum value sorter 43. The maximum value sorter 43 rearranges five differences input therein, in accordance with the order of their levels. The maximum value sorter 43 outputs one of the five differences, which has the maximum level, as a maximum value (dmax).

The acceptable defect removal circuit 33 selects one of the two differences d01 and d1112 to be left for an arithmetical operation for black defect correction, i.e., the larger one of them, and outputs it to the minimum value sorter 44. The minimum value sorter 44 rearranges five differences input therein, in accordance with the order of their levels. The minimum value sorter 44 outputs one of the five differences, which has the minimum level, as a minimum value (dmin).

The correction amount calculation part 36 includes two adders 45 and 46 and two weighting circuits 47 and 48. The adder 45 adds the dmax given from the maximum value sorter 43, to the D57L selected for white defect correction by the adjacent pixel selection circuit 34. The adder 45 outputs the addition result as Cmax1. The weighting circuit 47 applies weighting to the Cmax1. The color difference judgment circuit 30 outputs CmaxA obtained by the weighting in the weighting circuit 47, as a correction amount for white defect correction according to the color difference judgment.

The adder 46 adds the dmin given from the minimum value sorter 44, to the D57S selected for black defect correction by the adjacent pixel selection circuit 34. The adder 46 outputs the addition result as Cmin1. The weighting circuit 48 applies weighting to the Cmin1. The color difference judgment circuit 30 outputs CminA obtained by the weighting in the weighting circuit 48, as a correction amount for black defect correction according to the color difference judgment.

FIG. 6 is a flow chart showing a sequence of calculating a correction amount for white defect correction in the color difference judgment circuit shown in FIG. 3. In a step S1, the adjacent pixel selection circuit 34 selects one, which has a higher signal level, of the two different color pixels adjacent to the target pixel. The adjacent pixel selection circuit 34 compares the D5 and D7 with each other, and selects the larger one of them.

In a case where it is assumed that the target pixel has a white defect, the adjacent pixel selection circuit 34 selects one of the two different color pixels, which has a signal level closer to the signal level of the target pixel. The D57L output from the adjacent pixel selection circuit 34 is one of the signals thus selected from the D5 and D7.

In a step S2, the color difference calculation part 32 calculates the differences d01, d23, d45, d78, d910, and d1112 between the signal levels of the identical color pixels and the signal levels of the different color pixels. In a step S3, the acceptable defect removal circuit 33 compares the difference d01 with the difference d1112. The difference d01 is a difference calculated in association with an identical color pixel and a different color pixel positioned at the first end. The difference d1112 is a difference calculated in association with an identical color pixel and a different color pixel positioned at the second end.

The acceptable defect removal circuit 33 judges, about the identical color pixels at the opposite ends of the pixel group, that one identical color pixel corresponding to a larger difference has a higher possibility of being defective than the other identical color pixel. The color difference judgment circuit 30 regards the identical color pixel, which has been judged to have a higher possibility of being defective, as a defect to be accepted, regardless of being actually defective or not. The acceptable defect removal circuit 33 removes the larger one of the differences obtained from the identical color pixels at the opposite ends of the pixel group, from the sorting targets to be used in the maximum value sorter 43.

The acceptable defect removal circuit 33 selects the smaller one of the d01 and d1112 as an output. In the case of white defect correction, the acceptable defect removal circuit 33 selects the smaller one of the d01 and d1112, so that it removes a defect to be accepted from an arithmetical operation for white defect correction, and leaves the data of the identical color pixel other than the defect to be accepted.

The defect correction of the defect correction circuit 28 is assumed that one of the thirteen pixels forming the pixel group, which is the target pixel, has a defect. Further, the defect correction circuit 28 is provided with the acceptable defect removal circuit 33, so that it can accept a case where one of the identical color pixels at the opposite ends of the pixel group has a defect.

In a step S4, the maximum value sorter 43 rearranges the four differences d23, d45, d78, and d910 obtained in the step S2 and one difference selected in the step S3, in accordance with the order of their levels, and thereby chooses the dmax. In a step S5, the adder 45 adds the D57L obtained in the step S1 to the dmax obtained in the step S4. Consequently, the adder 45 calculates the Cmax1 serving as a clip value before adjustment. The relation Cmax1=dmax+D57L holds.

In a step S6, the weighting circuit 47 applies weighting to the Cmax1 obtained in the step S5, by multiplying it by a parameter. For example, the parameter is an arbitrary value between 1 and 2. As the value of the parameter is smaller, the effect of white defect correction performed by the color difference judgment circuit 30 is more enhanced. Consequently, the correction amount calculation part 36 calculates the CmaxA serving as a clip value after adjustment by the weighting. The relation CmaxA=Cmax1×“parameter” holds. The color difference judgment circuit 30 outputs the CmaxA as a correction amount for white defect correction according to the color difference judgment.

If there is no replacement with a correction amount according to flatness judgment or brightness judgment described later, and if the signal level of the target pixel exceeds the CmaxA, the defect correction circuit 28 replaces the signal of the target pixel with the CmaxA. This signal replacement is performed by the brightness judgment circuit 38 as described later. The defect correction circuit 28 uses the color difference judgment circuit 30 to perform an arithmetical operation for color difference judgment, which compares the color difference (D6-D57L) concerning the target pixel with the correction amount CmaxA obtained by adjusting the maximum value of the color differences concerning the neighboring pixels.

The sequence of calculating a correction amount for black defect correction is the same as the sequence explained with reference to the step S1 to the step S6, except that the magnitude relationship between values are suitably exchanged. In the case of black defect correction, the adjacent pixel selection circuit 34 selects the smaller one of the D5 and D7 (D57S).

The acceptable defect removal circuit 33 removes the smaller one of the differences obtained from the identical color pixels at the opposite ends of the pixel group, from the sorting targets to be used in the minimum value sorter 44. The acceptable defect removal circuit 33 selects the larger one of the d01 and d1112 as an output. In the case of black defect correction, the acceptable defect removal circuit 33 selects the larger one of the d01 and d1112, so that it removes a defect to be accepted from an arithmetical operation for black defect correction, and leaves the data of the identical color pixel other than the defect to be accepted.

The adder 46 adds the D57S to the dmin chosen by the minimum value sorter 44. The relation Cmin1=dmin+D57S holds. The weighting circuit 48 applies weighting to the Cmin1, by multiplying it by a parameter. For example, the parameter is an arbitrary value between 0 and 1. As the value of the parameter is larger, the effect of black defect correction performed by the color difference judgment circuit 30 is more enhanced. Consequently, the correction amount calculation part 36 calculates the CminA serving as a clip value after adjustment by the weighting. The relation CminA=Cmin1×“parameter” holds. The color difference judgment circuit 30 outputs the CminA as a correction amount for black defect correction according to the color difference judgment.

In this embodiment, it is assumed, about ordinary images, that the brightness level ratio (color ratio) between two colors detected by adjacent pixels has little probability of causing a significant change at a local region. According to this assumption, if a significant change in color ratio is found at a local region, a pixel at this region is estimated to have a defect.

The defect correction circuit 28 utilizes the color difference in place of the color ratio between adjacent pixels to perform defect judgment. The defect correction circuit 28 performs defect judgment by utilizing the color difference, and thereby allows the circuit scale and process load to be reduced, as compared with a case where it actually calculates the color ratio.

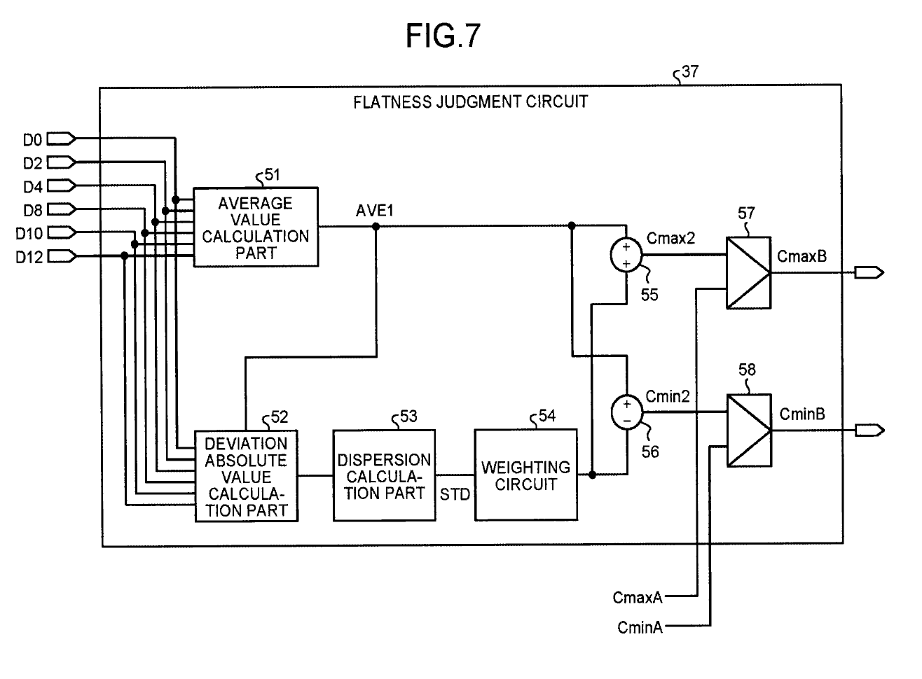

FIG. 7 is a view showing a configuration example of the flatness judgment circuit shown in FIG. 3. The flatness judgment circuit 37 includes an average value calculation part 51, a deviation absolute value calculation part 52, a dispersion calculation part 53, a weighting circuit 54, an adder 55, a subtractor 56, and selectors 57 and 58.

The signals (D0, D2, D4, D8, D10, and D12) of the six identical color pixels are input into the flatness judgment circuit 37 from the horizontal delay line 31 of the color difference judgment circuit 30. The average value calculation part 51 calculates the average value, as AVE1, of the signals of these six identical color pixels. The deviation absolute value calculation part 52 calculates the deviation absolute value of each of the signals of the six identical color pixels, based on the average value AVE1.

The dispersion calculation part 53 calculates a standard deviation (STD) indicating the dispersion of the signal levels, based on the deviation absolute values. The weighting circuit 54 applies weighting to the STD. The adder 55 adds the STD subjected to the weighting for white defect correction to the AVE1, and outputs the addition result as Cmax2. The selector 57 selects one, which has a lower level, of the Cmax2 from the adder 55 and the CmaxA serving as a clip value obtained by the color difference judgment circuit 30. The selector 57 outputs the selected signal (CmaxB).

The subtractor 56 subtracts the STD subjected to the weighting for black defect correction from the AVE1, and outputs the subtraction result as Cmin2. The selector 58 selects one, which has a higher level, of the Cmin2 from the subtractor 56 and the CminA serving as a clip value obtained by the color difference judgment circuit 30. The selector 58 outputs the selected signal (CminB).

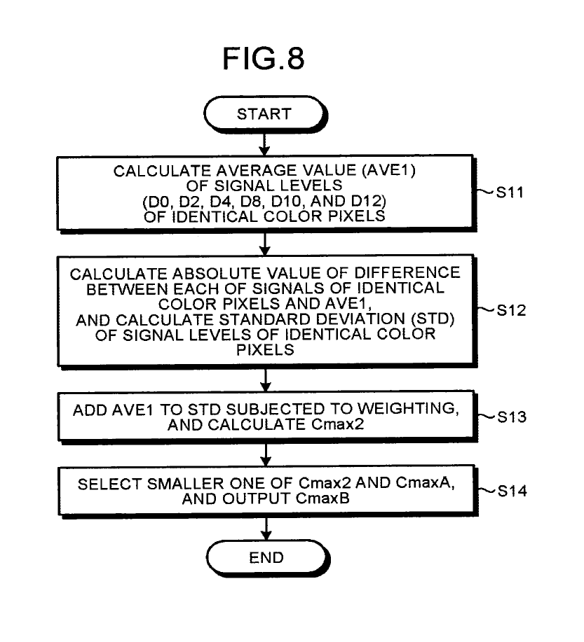

FIG. 8 is a flow chart showing a sequence of calculating a correction amount for white defect correction in the flatness judgment circuit shown in FIG. 3. In a step S11, the average value calculation part 51 calculates the average value AVE1 of the signal levels (D0, D2, D4, D8, D10, and D12) of the six identical color pixels. The average value calculation part 51 applies weighting to the signals of the two identical color pixels of the six identical color pixels, which are closest to the target pixel, such that this weighting is two times larger than those to the other identical color pixels. For example, the average value calculation part 51 calculates the AVE1, in accordance with the following formula.

AVE1=(D0+D2+D4×2+D8×2+D10+D12)/8

In a step S12, the deviation absolute value calculation part 52 calculates the absolute value of the difference between each of the signals of the six identical color pixels and the AVE1. The dispersion calculation part 53 calculates the standard deviation (STD) of the signal levels of the identical color pixels, based on the respective absolute values calculated by the deviation absolute value calculation part 52. The deviation absolute value calculation part 52 applies weighting to the two identical color pixels closest to the target pixel, such that this weighting is two times larger than those to the other identical color pixels. For example, the deviation absolute value calculation part 52 calculates the STD, in accordance with the following formula.

STD=(|D0−AVE1|+|D2−AVE1|+|D4−AVE1|×2+|D8−AVE1|×2+|D10−AVE1|+|D12−AVE1|)/8

The weighting circuit 54 applies weighting to the STD obtained in the step S12, by multiplying it by a parameter. For example, the parameter is an arbitrary value between 0 and 4. As the value of the parameter is smaller, the effect of white defect correction performed by the flatness judgment circuit 37 is more enhanced.

In a step S13, the adder 55 adds the AVE1 obtained in the step S11 to the STD subjected to the weighting in the step S12. Consequently, the adder 55 calculates the clip value Cmax2 as a correction amount for white defect correction according to the flatness judgment. The relation Cmax2=AVE1+STD×“parameter” holds.

In a step S14, the selector 57 selects the smaller one of the clip value Cmax2 obtained in the step S13 and the clip value CmaxA obtained in the step S6 (see FIG. 6). The flatness judgment circuit 37 outputs the signal selected by the selector 57 as a new clip value CmaxB subjected to the flatness judgment.

The sequence of calculating a correction amount for black defect correction is the same as the sequence explained with reference to the step S11 to the step S14, except that the magnitude relationship between values are suitably exchanged. In the case of black defect correction, for example, the parameter used for multiplying the STD in the weighting circuit 54 is an arbitrary value between 0 and 4. As the value of the parameter is smaller, the effect of black defect correction performed by the flatness judgment circuit 37 is more enhanced.

The subtractor 56 subtracts the STD subjected to the weighting from the AVE1. Consequently, the subtractor 56 calculates the clip value Cmin2 as a correction amount for black defect correction according to the flatness judgment. The relation Cmin2=AVE1−STD×“parameter” holds.

The selector 58 selects the lager one of the clip value Cmin2 from the subtractor 56 and the clip value CminA obtained by the color difference judgment circuit 30. The flatness judgment circuit 37 outputs the signal selected by the selector 58 as a new clip value CminB subjected to the flatness judgment.

The flatness judgment circuit 37 calculates a correction amount according to the flatness judgment, based on the dispersion of the signal levels of identical color pixels. When a correction amount according to the flatness judgment is smaller than a correction amount according to the color difference judgment, the flatness judgment circuit 37 replaces the correction amount according to the color difference judgment with the correction amount according to the flatness judgment. The flatness judgment circuit 37 sets the correction amount according to the flatness judgment at a smaller value, as the signal dispersion is smaller. As the dispersion is smaller, the defect correction circuit 28 performs replacement with a smaller correction amount according to the flatness judgment, to enhance the effect of defect correction in a flat area where brightness level variations are low. Consequently, the defect correction circuit 28 can perform effective defect correction to the flat area where defects tend to be conspicuous.

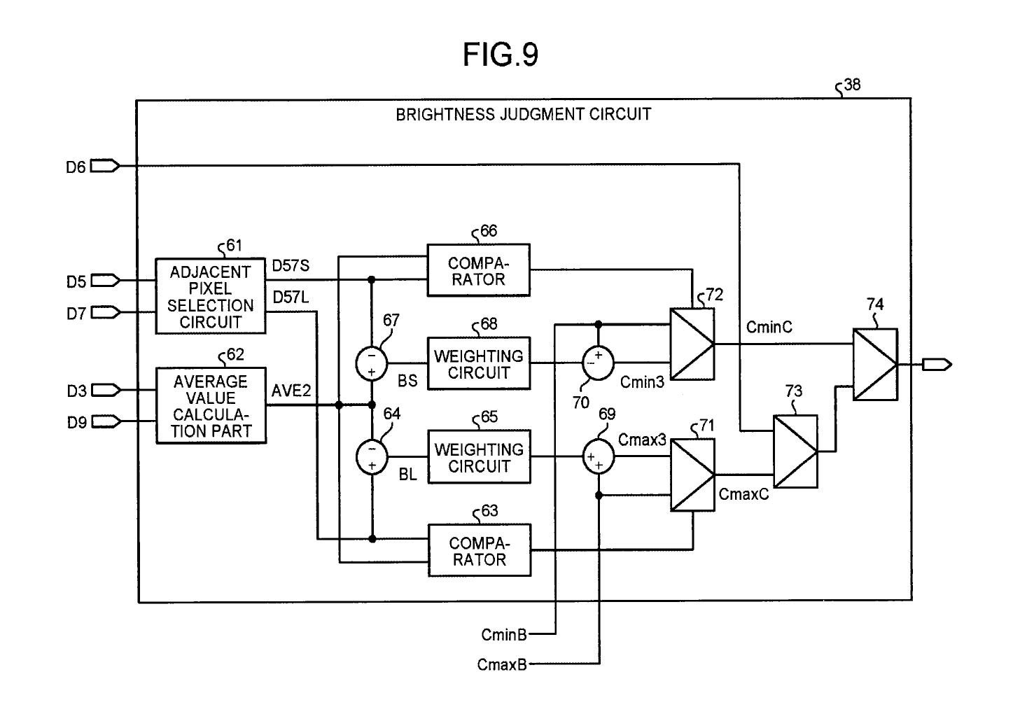

FIG. 9 is a view showing a configuration example of the brightness judgment circuit shown in FIG. 3. The brightness judgment circuit 38 includes an adjacent pixel selection circuit 61, an average value calculation part 62, comparators 63 and 66, difference calculators 64 and 67, weighting circuits 65 and 68, an adder 69, a subtractor 70, and selectors 71, 72, 73, and 74.

The signals (D3, D5, D7, and D9) of four different color pixels and the signal of the target pixel (D6) are input into the brightness judgment circuit 38 from the horizontal delay line 31 of the color difference judgment circuit 30. The signals D5 and D7 of the two different color pixels adjacent to the target pixel are input into the adjacent pixel selection circuit 61.

The adjacent pixel selection circuit 61 compares the D5 and D7 with each other. The adjacent pixel selection circuit 61 selects one, which has a higher signal level, of the D5 and D7, for white defect correction. The adjacent pixel selection circuit 61 outputs the selected signal (D57L). Further, the adjacent pixel selection circuit 61 selects one, which has a lower signal level, of the D5 and D7, for black defect correction. The adjacent pixel selection circuit 61 outputs the selected signal (D57S).

The signals D3 and D9 of different color pixels at positions separated by two pixels from the target pixel are input into the average value calculation part 62. The different color pixel corresponding to the D3 is adjacent to the identical color pixel corresponding to the D4. The different color pixel corresponding to the D9 is adjacent to the identical color pixel corresponding to the D8. The average value calculation part 62 calculates the average value, as AVE2, of the signals D3 and D9 of the two different color pixels.

The comparator 63 compares the D57L from the adjacent pixel selection circuit 61 with the AVE2 from the average value calculation part 62. The difference calculator 64 calculates the difference between the D57L and AVE2. This difference is considered as a brightness change amount (BL). The BL denotes a change amount between the brightness level of the different color pixels adjacent to the target pixel and the brightness level of the second closest different color pixels to the target pixel, next to the above-mentioned different color pixels. The weighting circuit 65 applies weighting to the BL.

The comparator 66 compares the D57S from the adjacent pixel selection circuit 61 with the AVE2 from the average value calculation part 62. The difference calculator 67 calculates the difference between the D57S and AVE2. This difference is considered as a brightness change amount (BS). The BS denotes a change amount between the brightness level of the different color pixels adjacent to the target pixel and the brightness level of the second closest different color pixels to the target pixel, next to the above-mentioned different color pixels. The weighting circuit 68 applies weighting to the BS.

The adder 69 adds the correction amount CmaxB obtained by the flatness judgment circuit 37 to the BL subjected to the weighting by the weighting circuit 65, and outputs the addition result as Cmax3. The selector 71 selects one of the Cmax3 from the adder 69 and the CmaxB from the flatness judgment circuit 37, in accordance with a comparison result obtained by the comparator 63. The selector 71 outputs the selected signal (CmaxC).

The subtractor 70 subtracts the BS subjected to the weighting by the weighting circuit 68 from the correction amount CminB obtained by the flatness judgment circuit 37, and outputs the subtraction result as Cmin3. The selector 72 selects one of the Cmin3 from the subtractor 70 and the CminB from the flatness judgment circuit 37, in accordance with a comparison result obtained by the comparator 66. The selector 72 outputs the selected signal (CminC).

The selector 73 selects one of the CmaxC from the selector 71 and the signal D6 of the target pixel. The selector 74 selects one of the signal from the selector 73 and the CminC from the selector 72. Each of the selectors 73 and 74 serving as a replacement circuit compares a correction amount obtained by any one of the color difference judgment circuit 30, the flatness judgment circuit 37, and the brightness judgment circuit 38 with the signal level of the target pixel. The selectors 73 and 74 replace the signal level of the target pixel with the correction amount, based on the comparison result.

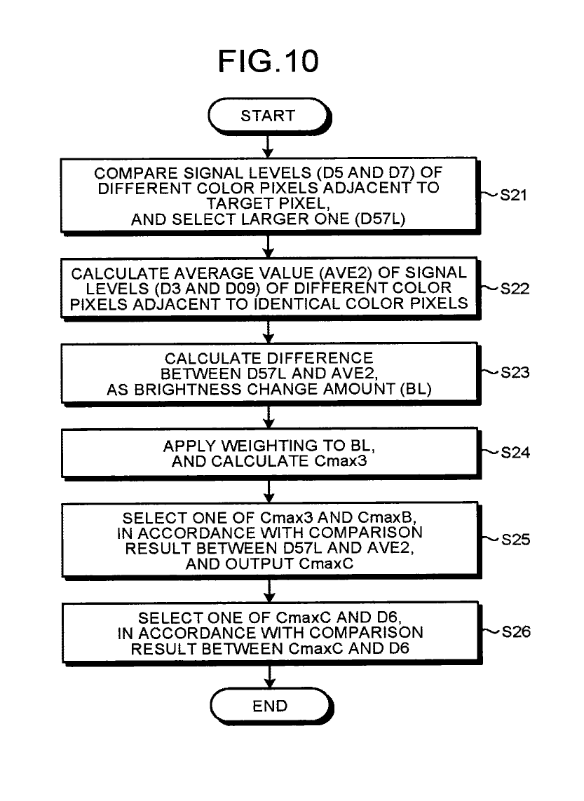

FIG. 10 is a flow chart showing a sequence of calculating a correction amount for white defect correction in the brightness judgment circuit shown in FIG. 3. In a step S21, the adjacent pixel selection circuit 61 selects one, which has a higher signal level, of the two different color pixels adjacent to the target pixel. The adjacent pixel selection circuit 61 compares the D5 and D7 with each other, and selects the larger one of them.

In a case where it is assumed that the target pixel has a white defect, the adjacent pixel selection circuit 61 selects one of the two different color pixels, which has a signal level closer to the signal level of the target pixel. The D57L output from the adjacent pixel selection circuit 61 is one of the signals thus selected from the D5 and D7.

In a step S22, the average value calculation part 62 calculates the average value AVE2 of the signal levels (D3 and D9) of different color pixels adjacent to identical color pixels. The relation AVE2=(D3+D9)/2 holds. In a step S23, the difference calculator 64 calculates the difference between the D57L obtained in the step S21 and the AVE2 obtained in the step S22. The difference calculator 64 outputs this difference as a brightness change amount BL. The relation BL=D57L−AVE2 holds.

In a step S24, the weighting circuit 65 applies weighting to the BL obtained in the step S23, by multiplying it by a parameter. For example, the parameter is an arbitrary value between 0 and 4. As the value of the parameter is smaller, the effect of white defect correction performed by the brightness judgment circuit 38 is more enhanced.

The adder 69 adds the CmaxB obtained in the step S14 (see FIG. 8) to the BL subjected to the weighting. Consequently, the adder 69 calculates the clip value Cmax3 as a correction amount for white defect correction according to the brightness judgment. The relation Cmax3=CmaxB+BL×“parameter” holds.

In a step S25, the selector 71 selects one of the Cmax3 obtained in the step S24 and the CmaxB obtained in the step S14, in accordance with a comparison result obtained by the comparator 63. For example, if the relation D57L>AVE2 is satisfied, the selector 71 selects the Cmax3. If the relation D57L≦AVE2 is satisfied, the selector 71 selects the CmaxB. The output CmaxC from the selector 71 is one of the signals thus selected from the Cmax3 and CmaxB.

In a step S26, the selector 73 selects one of the CmaxC obtained in the step S25 and the signal D6 of the target pixel, in accordance with a comparison result between the CmaxC and D6. For example, if the relation CmaxC<D6 is satisfied, the selector 73 selects the CmaxC. If the relation CmaxC≧D6 is satisfied, the selector 73 selects the D6.

The sequence of calculating a correction amount for black defect correction is the same as the sequence explained with reference to the step S21 to the step S26, except that the magnitude relationship between values are suitably exchanged. In the case of black defect correction, the adjacent pixel selection circuit 61 selects the smaller one of the D5 and D7 (D57S).

The difference calculator 67 calculates the difference between the D57S obtained by the adjacent pixel selection circuit 61 and the AVE2 obtained in the step S22. The difference calculator 67 outputs this difference as a brightness change amount BS. The relation BS=AVE2−D57S holds.

The weighting circuit 68 applies weighting to the BS obtained by the difference calculator 67, by multiplying it by a parameter. For example, the parameter is an arbitrary value between 0 and 4. As the value of the parameter is smaller, the effect of black defect correction performed by the brightness judgment circuit 38 is more enhanced.

The subtractor 70 subtracts the BS subjected to the weighting from the CminB obtained by the flatness judgment circuit 37. Consequently, the subtractor 70 calculates the clip value Cmin3 as a correction amount for black defect correction according to the brightness judgment. The relation Cmin3=CminB−BS×“parameter” holds.

The selector 72 selects one of the Cmin3 obtained by the subtractor 70 and the CminB obtained by the flatness judgment circuit 37, in accordance with a comparison result obtained by the comparator 66. For example, if the relation D57S<AVE2 is satisfied, the selector 72 selects the Cmin3. If the relation D57S≧AVE2 is satisfied, the selector 72 selects the CminB. The output CminC from the selector 72 is one of the signals thus selected from the Cmim3 and CmimB.

The selector 74 selects one of the CminC from the selector 72 and an input signal from the selector 73, in accordance with a comparison result between the CminC and D6. For example, if the relation CminC>D6 is satisfied, the selector 74 selects the CminC. If the relation CminC≦D6 is satisfied, the selector 74 selects the input signal from the selector 73.

When the CmaxC is selected in the step S26 as a correction amount for white defect correction, the relation CminC≦D6 is satisfied. Thus, the selector 74 selects the CmaxC serving as the input signal from the selector 73. When the D6 is selected in the step S26, and if the relation CminC≦D6 is satisfied, the selector 74 selects the D6 serving as the input signal from the selector 73. The brightness judgment circuit 38 outputs the signal thus selected by the selector 74.

When the correction amount CmaxC for white defect correction is output from the selector 74, the defect correction circuit 28 performs white defect correction by replacing the signal of the target pixel with the CmaxC. When the correction amount CminC for black defect correction is output from the selector 74, the defect correction circuit 28 performs black defect correction by replacing the signal of the target pixel with the CminC. When the D6 is output from the selector 74, the defect correction circuit 28 maintains the signal of the target pixel as the D6.

The brightness judgment circuit 38 calculates a correction amount according to the brightness judgment, based on a brightness change amount between the different color pixels adjacent to the target pixel and their neighboring different color pixels. In the case of white defect correction, the brightness judgment circuit 38 replaces a correction amount according to the color difference judgment and the flatness judgment with a correction amount according to the brightness judgment, when the signal level of the different color pixels adjacent to the target pixel is higher than the signal level of their neighboring different color pixels.

As the signal level of the different color pixels adjacent to the target pixel is more closer to the high brightness side than the signal level of their neighboring different color pixels, the brightness judgment circuit 38 sets a correction amount according to the brightness judgment to a larger value. When the target pixel and its adjacent different color pixels are higher in brightness than the other pixels, replacement is performed with a larger correction amount according to the brightness judgment, to weaken the effect of defect correction. Consequently, in the case of white defect correction, the defect correction circuit 28 prevents error correction from being performed on an image component that is displayed by continuous two pixels to be higher in brightness than the surroundings. Similarly, in the case of black defect correction, the defect correction circuit 28 prevents error correction from being performed on an image component that is displayed by continuous two pixels to be lower in brightness than the surroundings.

According to the embodiment, the defect correction circuit 28 performs defect correction by utilizing a pixel group composed of pixels present in a juxtaposed state in the horizontal direction. Thus, the defect correction circuit 28 makes a line memory unnecessary and can thereby reduce the circuit scale, as compared with a case where it performs defect correction by utilizing information about pixels in two-dimensional directions. Since the defect correction circuit 28 can reduce the circuit scale, it can reduce the power consumption.

For example, it is assumed there is an image component displayed by three pixels composed of the target pixel and its adjacent two different color pixels. If information about different color pixels is supposed to be not utilized, the defect correction circuit 28 may judge that the target pixel has a defect, by referring only to information about identical color pixels. On the other hand, according to the embodiment, the defect correction circuit 28 performs defect correction by utilizing information about identical color pixels and different color pixels belonging to the pixel group. Thus, the defect correction circuit 28 can reduce error correction, as compared with a case where it performs defect correction without utilizing information about different color pixels.

In a case where there is an image component having a brightness level prominent from the surroundings, over continuous two pixels or three pixels including the target pixel, the defect correction circuit 28 can reduce error correction on the target pixel. As a result, the solid-state imaging device 14 provides an effect capable of reducing the circuit scale and reducing error correction to form high quality images.

The pixel array 22 may have a pixel sharing structure where a plurality of pixels in a cell share a MOS transistor serving as a pixel component. In a configuration where each of the cells is formed to include a plurality of pixels arrayed in the vertical direction, the plurality of pixels arrayed in the vertical direction may become defective. For example, in a 4V1H pixel sharing structure where pixels are arranged with one pixel in the horizontal direction and four pixels in the vertical direction, there may be a case where four defects are generated side by side in the vertical direction.

According to the embodiment, the defect correction circuit 28 refers to a pixel group in the horizontal direction, and can thereby respectively process a plurality of defects present in the vertical direction as one defect in each pixel group. The defect correction circuit 28 can calculate a correction amount while more clearly removing information about the defective pixel, as compared with a case where it performs defect correction by utilizing information about pixels in two-dimensional directions. Consequently, the defect correction circuit 28 can reduce error correction in the pixel sharing structure where a plurality of pixels are arrayed in the vertical direction. For example, in a 4V1H pixel sharing structure, the defect correction circuit 28 can accurately correct four defects generated side by side in the vertical direction.

In the defect correction circuit 28, the number of pixels included in the pixel group is not limited to 13, but may be suitably changed. For example, the defect correction circuit 28 may perform defect correction based on a pixel group including thirteen pixels, and it can thereby reduce error correction on an image including a pattern of ⅓ Nyquist frequency.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
an image sensor including a pixel array composed of pixels arrayed in horizontal directions and vertical directions; and
a signal processing circuit configured to process image signals from the image sensor,
wherein the signal processing circuit includes a defect correction circuit configured to correct a signal level of a target pixel judged as a defect by comparing signals of a pixel group including the target pixel, the pixel group including pixels juxtaposed in a horizontal direction with the target pixel at a center, and
the defect correction circuit includes
a color difference calculation part configured to calculate a difference between a signal level of a first pixel for detecting first color light in the pixel group and a signal level of a second pixel for detecting second color light, the second pixel being adjacent to the first pixel in the pixel group,
a color difference sorting part configured to choose one of differences calculated by the color difference calculation part in association with first pixels and second pixels included in the pixel group, and
a correction amount calculation part configured to calculate a correction amount for the target pixel, based on a difference chosen by the color difference sorting part and a signal level of a second pixel adjacent to the target pixel.

2. The solid-state imaging device according to claim 1, wherein the color difference sorting part is configured to choose a maximum value of differences calculated by the color difference calculation part, and
the correction amount calculation part is configured to calculate the correction amount, based on the maximum value.

3. The solid-state imaging device according to claim 1, wherein the color difference sorting part is configured to choose a minimum value of differences calculated by the color difference calculation part, and
the correction amount calculation part is configured to calculate the correction amount, based on the minimum value.

4. The solid-state imaging device according to claim 1, wherein the defect correction circuit further includes an adjacent pixel selection part configured to select one of two second pixels adjacent to the target pixel, in accordance with a result of comparing signal levels of the two second pixels, and
the correction amount calculation part is configured to calculate the correction amount by adding a signal level of a second pixel selected by the adjacent pixel selection part to a difference chosen by the color difference sorting part.

5. The solid-state imaging device according to claim 4, wherein the adjacent pixel selection part is configured to select a second pixel, which has a higher signal level, of the two second pixels.

6. The solid-state imaging device according to claim 4, wherein the adjacent pixel selection part is configured to select a second pixel, which has a lower signal level, of the two second pixels.

7. The solid-state imaging device according to claim 1, wherein the defect correction circuit further includes an acceptable defect removal part configured to remove one of two first pixels from an arithmetical operation, as a defect to be accepted in the pixel group, and
the two first pixels are a first pixel positioned at a first end of the pixel group in a horizontal direction and a first pixel positioned at a second end opposite to the first end.

8. The solid-state imaging device according to claim 7, wherein the acceptable defect removal part is configured to remove one of two differences from sorting targets in the color difference sorting part, in accordance with a result of comparing the two differences with each other, and
the two differences are a difference calculated in association with a first pixel and a second pixel positioned at the first end and a difference calculated in association with a first pixel and a second pixel positioned at the second end.

9. The solid-state imaging device according to claim 1, wherein the defect correction circuit further includes a brightness judgment circuit configured to calculate a correction amount according to brightness judgment, based on a brightness change amount between a second pixel adjacent to the target pixel and a second pixel adjacent to a first pixel, and
the defect correction circuit is configured to replace the correction amount calculated by the correction amount calculation part with a correction amount according to the brightness judgment.

10. The solid-state imaging device according to claim 1, wherein the defect correction circuit further includes a flatness judgment circuit configured to calculate a correction amount according to flatness judgment, based on a dispersion of signal levels of the first pixels, and
the defect correction circuit is configured to replace the correction amount calculated by the correction amount calculation part with a correction amount according to the flatness judgment.

11. A signal processing method to be performed in a signal processing circuit of a solid-state imaging device, the method comprising:
calculating a difference between a signal level of a first pixel for detecting first color light and a second pixel for detecting second color light, the first pixel being included in a pixel group including pixels juxtaposed in a horizontal direction with a target pixel at a center, the second pixel being adjacent to the first pixel in the pixel group;
choosing one of differences calculated in association with first pixels and second pixels included in the pixel group, and
calculating a correction amount for defect correction on the target pixel, based on a difference thus chosen and a signal level of a second pixel adjacent to the target pixel in the pixel group.

12. The signal processing method according to claim 11, comprising:
choosing a maximum value of the differences calculated; and
calculating the correction amount, based on the maximum value.

13. The signal processing method according to claim 11, comprising:
choosing a minimum value of the differences calculated; and
calculating the correction amount, based on the minimum value.

14. The signal processing method according to claim 11, further comprising:
selecting one of two second pixels adjacent to the target pixel, in accordance with a result of comparing signal levels of the two second pixels,
wherein the method calculates the correction amount by adding a signal level of a second pixel thus selected to the difference chosen.

15. The signal processing method according to claim 11, further comprising:
removing one of two first pixels from an arithmetical operation, as a defect to be accepted in the pixel group,
the two first pixels being a first pixel positioned at a first end of the pixel group in a horizontal direction and a first pixel positioned at a second end opposite to the first end.

16. The signal processing method according to claim 15, comprising:
removing one of two differences from sorting targets, in accordance with a result of comparing the differences with each other,
the two differences being a difference calculated in association with a first pixel and a second pixel positioned at the first end and a difference calculated in association with a first pixel and a second pixel positioned at the second end.

17. The signal processing method according to claim 11, further comprising:
calculating a correction amount according to brightness judgment, based on a brightness change amount between a second pixel adjacent to the target pixel and a second pixel adjacent to a first pixel; and
replacing the correction amount for the defect correction with a correction amount according to the brightness judgment.

18. The signal processing method according to claim 11, further comprising:
calculating a correction amount according to flatness judgment, based on a dispersion of signal levels of the first pixels; and
replacing the correction amount for the defect correction with a correction amount according to the flatness judgment.

19. A solid-state imaging device comprising:
an image sensor including a pixel array composed of pixels arrayed in horizontal directions and vertical directions; and
a signal processing circuit configured to process image signals from the image sensor,
wherein the signal processing circuit includes
a selection circuit configured to compare signal levels of two pixels adjacent to a target pixel in a horizontal direction, and to select one of signals of the two pixels, based on a comparison result;
a plurality of difference calculators each configured to calculate a difference between signal levels in association with a combination of a first pixel and a second pixel adjacent to the first pixel, in a pixel group including pixels juxtaposed in a horizontal direction with the target pixel at a center,
a sorting circuit configured to choose one of differences obtained by the plurality of difference calculators, in accordance with an order of levels of the differences;
an adder configured to add a difference chosen by the sorting circuit to a signal selected by the selection circuit; and
a replacement circuit configured to compare a correction amount based on an addition result obtained by the adder with a signal level of the target pixel, and to replace the signal level of the target pixel with the correction amount, in accordance with a comparison result.
